(19) United States
(12) Patent Application Publication
(10) Pub. No.: US 2008/0148514 A1
(43) Pub. Date: Jun. 26, 2008

(54) DIRECTION STABILIZED COMPACT SWIVEL CASTER

(76) Inventors: Garry W. Hancock, Boonville, IN (US); Marcell D. Baker, Portland, TN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/613,727

(22) Filed: Dec. 20, 2006

(51) Int. Cl. B60B 33/00

(52) U.S. Cl. 16/21; 16/20

(57) ABSTRACT

A swivel caster assembly has a spring-loaded detent pin in a cylinder threaded into a nut mounted to the underside of the caster horn top. A lower bearing race has detent notches in an outer peripheral surface under the caster horn top and engage-able by the pin to control directional orientation of the horn relative to a load carried by it. The cylinder is adjustable by turning the cylinder in the nut, to change the amount of orientation control. The detent features are concealed under the top portion of the horn.

### BACKGROUND

This invention relates generally to casters for support of an object intended to roll along a floor surface. A variety of casters for such purposes is known. Many swivel freely to facilitate rolling an object in whatever direction the object is pushed or pulled. Some of them have a swivel locking feature. Some have a brake to prevent the caster from rolling. Some have a combination of swivel and lock.

A problem frequently encountered with swivel casters is a fluttering characteristic, particularly when the object supported on them is pushed or pulled and one or more of the casters encounter irregular surfaces. Fluttering can also occur when a frame which has four swivel casters on, has been bent or otherwise damaged so that one caster is not continuously and fully-engaged with the surface on which the object is being moved.

Another problem with swiveling casters is that, where the floor on which the casters are rolling is sloped to the side of a direction on which the cart or other object supported by the casters is being pushed or pulled, there is a tendency of the object to drift sideways down the slope and become difficult to control.

Another problem often associated with casters, particularly when exposed to or operating in an environment which is dusty or in which the floor surface is dirty, or wet with water or other fluids, is the accumulation of dirt on the caster wheel, axle, or swivel assembly, or all of these aspects. In addition to interfering with performance of such casters, such environments tend to deteriorate the appearance of the caster.

It is also possible for there to be instances in which a object supported by casters is adapted for operation by remote control or otherwise in a circumstance where the performance of a caster or casters is not readily detectable. In some such instances, a caster wheel or swivel or both may become jammed or impeded by dirt or in some other manner.

In view of the foregoing, and notwithstanding the many types of casters that have been developed in the prior art, there remains a need for a caster assembly which better addresses one or more of the foregoing problems.

### SUMMARY

A swivel caster assembly has an adapter for fixing to an object to be supported by the caster assembly for rolling the object along a floor in a direction. A wheel mounted horn is swivel mounted to the adapter. A first detent member is fixed to the adapter and has a detent recess. A second detent member is movably mounted to the horn and co-operable with the recess in the first detent member as the object is rolled along a floor to minimize flutter as the object moves along. The detent members are concealed under a top portion of the horn.

### BRIEF DESCRIPTION OF THE DRAWINGS

FIG. 1 is a side elevation view of a caster assembly incorporating features according to an illustrated embodiment of the present invention.

FIG. 2 is a rear elevation view thereof.

FIG. 3 is a side elevation view with the upper portion shown in section taken at line 3-3 in FIG. 2 and viewed in the direction of the arrows.

FIG. 3A is an enlargement of a portion of FIG. 3.

FIG. 4 is a top plan view of the caster assembly.

FIG. 5 is an enlarged top plan view of the lower bearing-ball retainer and the spring-loaded detent pin in a detent notch in the retainer.

### DESCRIPTION OF THE ILLUSTRATED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended.

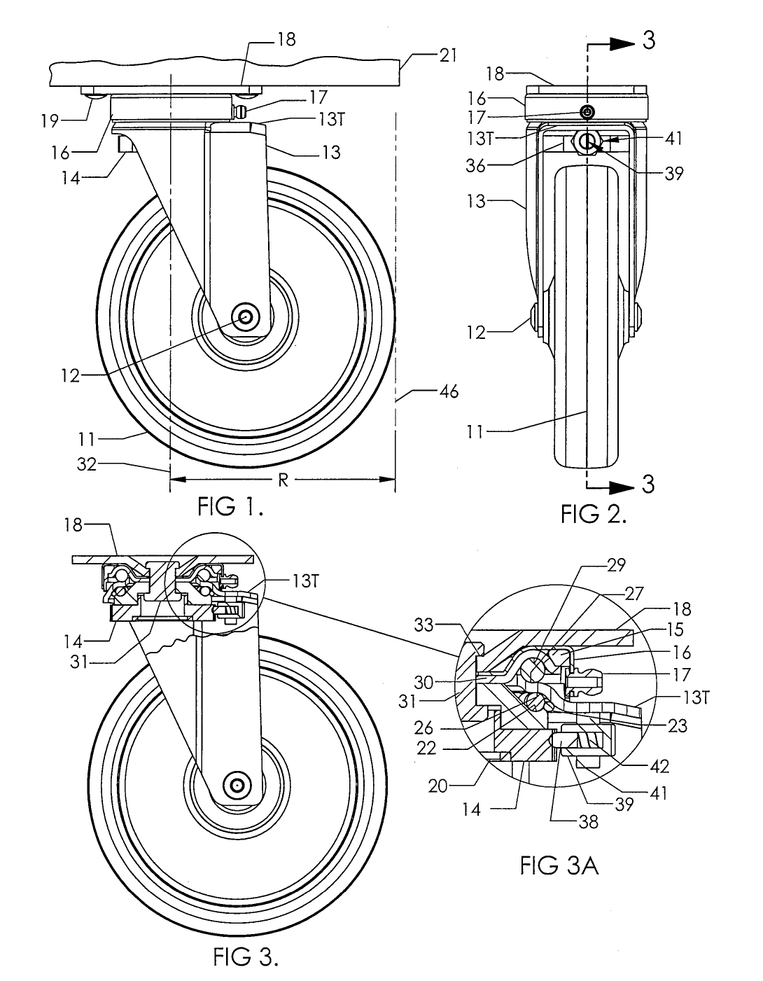

Referring now to the drawings in detail, and FIGS. 1 and 2 in particular, the illustrated caster assembly includes a wheel 11, axle 12, horn 13, upper dust cap 16, grease fitting 17, mounting plate 18, and screws 19 or other fasteners securing the caster assembly to the object 21 (shown fragmentarily) and which is supported by this and other like caster assemblies (not shown). The horn has two horizontally-spaced legs and a top portion 13T serving as a bridge across the space at the top of the legs.

Referring now to FIG. 3, the caster assembly includes an anti-friction bearing assembly in the form of a double ball-bearing assembly centered on a vertical axis 32. The lower race 22 for the lower set of bearing balls has a lower retainer 14 which is welded or otherwise connected to it. The top portion 13T of the horn is shaped with a first and downward-facing groove 26 serving as the upper race and upper retainer for the lower set of bearing balls. The top portion 13T of the horn also has an upward-facing groove 27 serving as the lower race for the upper set of bearing balls. A top retainer 30 has a downward-facing groove 29 serving as the upper race for the upper set of bearing balls. The top retainer also provides the seat for the grease seal 15 and dust cap 16 and the mounting plate 18 of the caster assembly. An outboard seal for the balls in the lower set is provided by an O-ring 23 received in a gap between the lower race 22 and the underside of the horn top portion 13T.

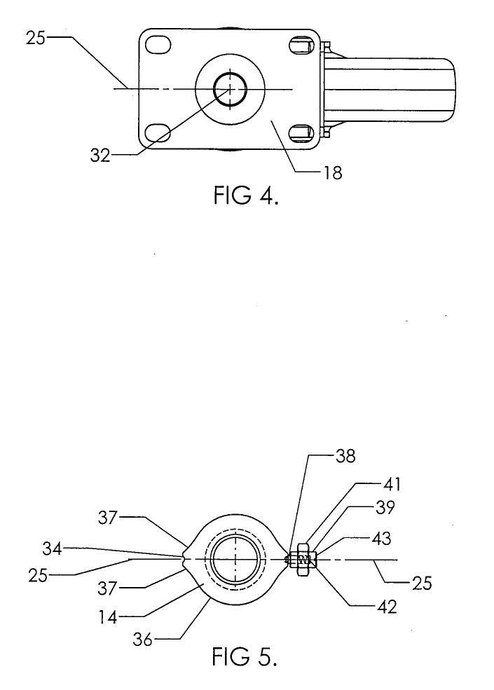

The horn and bearing assembly are connected together by a kingpin 31, the upper end of which, prior to being staked, is passed through center holes in the lower retainer 14, the lower race 22, the upper retainer 30, the dust cap 16 and the mounting plate 18 to which the upper-end of the kingpin is staked at 33. Consequently, the mounting plate 18, kingpin 31, dust cap 16, upper retainer 30, lower race 22, and lower retainer 14 become fixed together when the king pin is staked to plate 18. They are fixed to the object 21 by screws 19 or the like through the four holes (FIG. 4) in plate 18, while the horn and wheel are free to swivel about the axis 32. The grease fitting 17 is staked to the dust cap 16 prior to assembly, and is exposed directly under the mounting plate 18 at the rear of the caster assembly. A bottom dust cap 20 snaps into a recess in the lower retainer 14.

While the caster horn with wheel can freely swivel about the axis 32, the swiveling is controllable at two locations 180 degrees apart. For that purpose, the lower retainer 14, as best shown in FIG. 5, has two detent recesses, such as notches 34, for example, on its outer and otherwise generally-cylindrical face 36. These notches are diametrically oppositely-located at opposite ends of a line 25 extending through and perpendicular to the swivel axis. Each of these notches has a ramp 37 rising outward from the cylindrical face 36, with the detent notch at the end of each of the ramps. A spring-loaded rounded-end plunger 38 is received in an externally-threaded cylinder 39 mounted in a hex nut 41 serving as a bracket fixed to the underside of the top portion of the caster horn and generally above the axle 12. A coil spring 42 inside the cylinder has one end abutting the inner end of the plunger 38 and the other end abutting the inside closed end of cylinder 39. The outside closed end of cylinder 39 has a screwdriver slot or other tool receiver feature and can be turned to move the cylinder closer to or away from cam surface 36 to increase or decrease the spring load on the plunger.

This detent arrangement being at opposite ends of line 25 through swivel axis 32, dictates that once the caster assembly is oriented, with the horn in one or the other of the two detented orientations relative to the mounting plate, the caster will remain in that orientation and acts like a rigid caster when moved forward or backward in straight-line movement. When sufficient side forces are applied, the plunger end can be forced out of the notch and down one or the other of the ramps adjoining the notch so the horn with wheel can swivel until returning to either an original forward position in FIG. 1, or a 180 degree (backward) position.

It is important that the mounting of the caster assembly to the object 21 being supported by it, makes the line 25 parallel to the intended rolling direction of the object 21. For example, the long axis of plate 18 is parallel to line 25. An adapter mounting the caster assembly to the object 21 could be shaped different from plate 18, but should align the detent line 25 with intended direction of forward or backward rolling of the object 21.

In either forward or backward position of the caster, because of the compact nature of the caster, the whole caster assembly, including the wheel, is within the downward projection (the dashed line 46 in FIG. 1) from an edge of the object 21 to which the caster assembly is mounted. Consequently, the object 21 can be moved either forward or backward without the wheel extending beyond the downward projection of the object on which it is mounted. Nothing projects outward beyond the swivel radius R.

As noted above, the threaded cylinder 39 with internal plunger and spring are attached underneath the trailing side of the top portion of the caster horn. The detent notches are within the vertical downward projection of the lower retainer 14. Therefore they are not readily visible and do not cause interference with anything outside the swivel radius of the caster assembly. In addition, because the detent apparatus is totally under the top portion of the caster horn and has a minimal number of parts, simplicity and cleanliness are promoted. There is no interference with the caster mounting or with the grease fitting which is protected and hidden under the mounting plate. The combination offers simplicity of function while maintaining the neat appearance of the caster assembly. Moreover, it is well adapted to wash-down operations on the object to which such caster assemblies may be mounted. The detent adjustment feature makes the assembly easily adjustable for various applications and operating conditions.

The horn is shown in the illustrations herein, as having two spaced leg portions, with a top portion offset toward the center of the space at the top of the leg portions, forming a bridge connecting the leg portions. The invention can be practiced with a single leg portion supported by the wheel, and the top portion cantilevered from the leg portion and still provide bearing race retainers and swivel axis and detent apparatus coverage as in the illustrations herein. Therefore, while an embodiment of the invention has been illustrated and described in detail in the drawings and foregoing description, the same is to be considered as illustrative and not restrictive in character, it being understood that all changes and modifications that come within the spirit of the invention are desired to be protected.

What is claimed is:

1. A caster assembly for supporting an object movable along a floor, said assembly comprising:
a wheel for rolling on a floor;
a horn connected to the wheel for support of the horn above the floor, said horn having a top portion and having a leg portion extending downward from said top portion, the wheel being received under the top portion and beside the leg portion;
a swivel for mounting the horn to an object to be supported by the caster assembly while the object is rolled along the floor, said swivel including a first portion arranged for attachment to said object and said swivel having a second portion on the top portion of said horn and facilitating swiveling of said horn relative to said first portion about a vertical axis;
a first detent member fixed relative to said first portion of said swivel;
said first detent member having a receiver under said top portion of said horn for receiving a second detent member; and
a second detent member mounted to said horn under said top portion of said horn and engage-able with said receiver to inhibit swiveling of said horn relative to said object.

2. The caster assembly of claim 1 and wherein:
said first detent member has a surface centered on said axis; and
said second detent member is a pin engage-able with said receiver.

3. The caster assembly of claim 2 and wherein:
said first detent member has a second receiver for said detent pin; and
said receivers are at opposite ends of a line which is perpendicular to said axis and intersects said axis at a location about midway between said ends of said line.

4. The caster assembly of claim 1 and wherein:
said swivel includes a mounting portion for fixing to said object to establish a fixed relationship of said mounting portion to said object.

5. The caster assembly of claim 4 and wherein:
said receiver has a fixed orientation relative to said mounting portion.

6. The caster assembly of claim 3 and wherein:
said surface centered on said axis is a generally-circular perimeter surface;
said receivers are recesses in said perimeter surface;
said pin is biased to engage said perimeter surface; and
said perimeter surface has cam ramp surfaces ascending from each side of each of said recesses to the respective recess, to increase the bias of said pin until the pin enters the respective recess, but each of said recesses is shallow enough to maintain a pin bias in the respective recess.

7. The caster assembly of claim 6 and wherein:
said second detent member includes a cylinder containing a resilient member and a portion of said pin;
a threaded bracket is fixed to said horn under said top portion; and
said cylinder is threaded into said bracket under said horn and is adjustable by rotation in said bracket to selectively increase or decrease the amount of bias of said pin against said perimeter surface.

8. The caster assembly of claim 1 and wherein:
said first portion of said swivel includes a mounting plate;
the swivel axis of the horn is laterally offset from the leg portion;
the horn has a second leg portion laterally offset from the first-mentioned leg portion;
the top portion of said horn provides a bridge between the first-mentioned leg portion and the second leg portion;
said first detent member is covered by said bridge; and
said second detent member is covered by said bridge.

9. The caster assembly of claim 8 and further comprising:
upper and lower ball bearings and wherein;
said upper bearings are located between said bridge and said mounting plate, and said lower bearings are located between said bridge and said first detent member, and said first detent member is located between said wheel and said bearings.

10. The caster assembly of claim 9 and further comprising:
a dust shield around said upper bearings;
a grease fitting on said dust shield for admitting grease from a gun outside the dust shield to the bearings, and wherein the grease fitting is above the caster horn but within an area bounded by a vertical projection of the portion of the horn most remote from said axis.

11. The caster assembly of claim 10 and further comprising:
a king pin fixed to said mounting plate and to said first detent member and holding together said mounting plate, said upper bearings, said horn, said lower bearings and said first detent member.

12. The caster assembly of claim 11 and further comprising:
a dust cap closing a cavity in the first detent member and shielding said king pin.

13. The caster assembly of claim 12 and wherein:
said king pin is staked to said mounting plate, and said mounting plate is configured for mounting to the object to be rolled along said floor.

14. The caster assembly of claim 8 and further comprising:
an adjustment screw covered by said bridge of said horn and supporting said second detent member and exposed under a trailing edge of the bridge for access to an adjusting tool entering under the trailing edge of the bridge.

15. The caster of claim 3 and further comprising;
caster orientation means on said mounting plate orienting said mounting plate to the direction of said line between said recesses to facilitate correct orientation of the caster assembly on the moveable object, to establish on object a direction of stabilized rolling movement.
